(19) United States
(12) Patent Application Publication
(10) Pub. No.: US 2007/0129995 A1
(43) Pub. Date: Jun. 7, 2007

(54) Performance-based marketing system and method

(76) Inventor: Mitchell D. Brandow, Fall City, WA (US)

Correspondence Address: STOEL RIVES LLP - SLC, 201 SOUTH MAIN STREET, ONE UTAH CENTER, SALT LAKE CITY, UT, 84111, US

(21) Appl. No.: 11/633,318

(22) Filed: Dec. 4, 2006

Related U.S. Application Data
(60) Provisional application No. 60/597,450, filed on Dec. 2, 2005.

(51) Int. Cl. G07G 1/00

(52) U.S. Cl. 705/10

(57) ABSTRACT

Systems and methods are provided for tracking new customer contacts to reward agency performance. A client tracking website is generated which includes tracking contact information usable by a customer to contact a client. A new customer contact database is provided to receive and log contact information when a customer uses the tracking contact information to contact a client. The contact information is analyzed to generate a new customer contact list including new customer contacts.

### RELATED APPLICATIONS

The application claims priority to U.S. Patent Application No. 60/597,450, entitled “Performance-Based Marketing System and Method” which was filed on Dec. 2, 2005, and which is incorporated herein by reference.

### TECHNICAL FIELD

This disclosure relates generally to techniques for tracking and reporting new customer contacts initiated by a marketing agency in an on-line environment.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of a system and method to offer advertising services and track new customer contacts.

FIG. 2 is a flow diagram of a process for creating a tracking website.

FIG. 3 is a flow diagram of a process for determining new customer contacts for clients.

FIG. 4 is a block diagram of an alternative system and method to offer advertising services and track new customer contacts for clients.

### DETAILED DESCRIPTION

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Several aspects of the embodiments may be implemented by software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

An agency-client business relationship within the advertising industry is typically based on a commission structure, with the agency receiving an agreed upon percentage of the dollars spent on media and/or production. Although some agency-client businesses rely on flat fee retainers, even in these cases the actual fee may be based on the approximate size of the media and production spend. Sometimes performance-based incentives are built into the individual contract, but these incentives may be structured to deliver incremental revenue additive to the main fee, which makes up the majority of the compensation.

These agency-client business relationships have become increasingly flawed, as clients seek to maximize the productivity of their return on investment. In the agency-client business relationship model that has been prominent for many years, the agency has incentive to maximize the amount a client spends on media and production. The client has incentive to maximize the results of the overall advertising. Results may be defined as any predetermined metric of success or goal, such as total sales, gross revenue, net revenue, customer leads, or perception of the client's brand in the marketplace. This inherent discord in goals between the client and the agency often leads to decreased productivity and efficiency in the spending of advertising dollars to achieve business results. Most healthy business relationships thrive when both parties' interests are aligned and both parties are making money. In the current agency-client relationships, this is oftentimes not the case.

Some businesses have arisen as exceptions to the above. Often referred to as lead-generating companies, these companies often charge clients a flat fee per lead that is generated by the company. Usually these lead-generating companies serve as intermediates between the clients and the customer. The lead-generating company advertises their brand directly to the customer, offering to match the customer to multiple clients in any given category. Oftentimes the clients' services are local in nature, and thus the lead-generating company obtains geographical information from the customer. This geographical information enables the lead-generating company to match the customer to clients in their area. Most often, the lead-generating company then sells the same customer lead to multiple providers within that area. Although this performance-based compensation is a step forward from the previously described typical agency-client business relationship, there are inherent problems to this model, particularly from the point-of-view of the client.

A number of problems exist with the typical lead-generating business structure. One problem occurs because the lead-generating business is advertising their own brand to the customer and the actual client is not able to effectively differentiate their brand from competitors. Another problem occurs because the leads may be sold to multiple parties. The client is forced to compete against other providers in a similar business category. Because of these problems, leads from lead-generating companies position the client as a commodity and thus the client may have difficulty maximizing pricing. Although some lead-generating businesses are now offering exclusive leads that are only sold to a single provider at a much higher rate than a non-exclusive lead, the commoditizing effects remain, and the individual client is not able to competitively position their brand or communicate their unique selling proposition.

With the current major search engines for use on the world wide web, it is possible for clients to purchase search advertising directly through their self-service advertising interfaces. This has two potential problems. First, search advertising is becoming increasingly complex, and attempts to keep up with the latest technical capabilities of the search engines is time intensive. This oftentimes requires the hiring of full-time employee(s) to handle search advertising. Many companies, particularly those that are small to medium-sized enterprises, do not have the time, money or resources to dedicate to search marketing in order to achieve an efficient return on investment. Second, many companies do not find inherent value in a “click.” This is problematic since most search advertising is paid on a “cost-per-click” basis, where charges are incurred every time a customer clicks on a paid search ad to be taken to the client's website.

Based on the two issues delineated above, most businesses decide they are better off hiring a third party to handle search engine marketing. In so doing, if they are able to off-load the risk of the pay-per-click media advertising to the third party, and only pay when a customer takes the subsequent step of contacting them, then a business successfully removes a financial risk from their business which is in keeping with sound business practices. The marketing technology outlined herein enables the business to reduce their risk in this manner.

Some companies have begun to offer what is commonly referred to as “pay-per-call,” which is different from the concept of a “new customer contact.” In the pay-per-call business model, companies do not allow customers to actually visit a client's website. By doing this, the pay-per-call business is limited by both the customer experience and the client's ability to differentiate their business through a unique, branded website. Thus, the quality of the calls generated is typically of lower value than a new customer contact obtained after a customer visits a client's actual website.

As described herein, clients advertise directly to customers using search advertising through an agency whose primary compensation is a fee per “new customer contact” that the agency delivers to the client. The agency may pay for media costs, as well as all other technology, creativity, and management costs of the advertising. However, the agency is only compensated when the customer actually contacts the client such as via telephone or e-mail.

The business model differs from the typical agency-client business relationship. The risk of the media expenses is taken on by the agency, instead of the client. Through this relationship, the agency has incentive to maximize new customer contacts, and thus maximize the results for the client, while at the same time minimizing actual media costs to achieve the new customer contacts. The agency has no incentive to maximize media costs of the client in order to maximize its own revenues. Through this business model, the interests of the agency are effectively aligned with the client, resulting in a business relationship that is mutually beneficial and driven towards the goal of achieving results for the client.

The proposed business model is also different from the typical lead-generating company. Under suitable embodiments, the agency does not advertise its brand to the customer. Instead, the agency may be transparent to the customer who is searching for the products and services that a client provides. In so doing, the agency is not an intermediary, like the typical lead-generating company. When a customer clicks on a search ad that the agency has purchased, the customer is not taken to the agency's website. Instead, the customer is taken directly to a website for the client, enabling the client to competitively position their brand and unique selling proposition, thereby avoiding the commoditizing effect of the typical lead-generating company.

By advertising directly to the customer, the client may be able to achieve a much higher quality of customer contact, where quality is defined as the proclivity of the customer to not simply be searching for the lowest price and looking for clients to “compete for their business.” Along these same lines, since the customer contacts the client directly, by its very nature the customer contact is exclusive and not simultaneously forwarded to multiple competitors in a business category, as may be the case with lead-generating companies. The marketing technology in some exemplary embodiments may be implemented as a process that offers an advertising service that is priced on a cost per new customer contact basis.

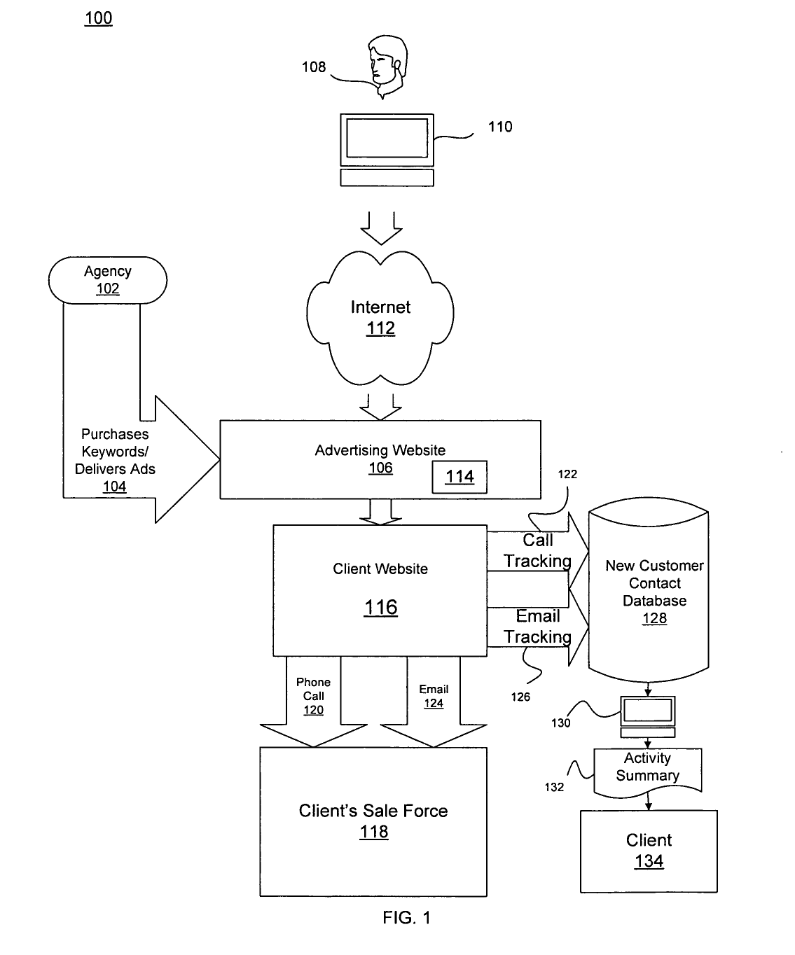

Referring to FIG. 1, a block diagram of a marketing system and process 100 used to offer advertising services and track new customer contacts is shown. An agency 102 purchases keywords 104 relevant to the client's business goals that may be entered on a website 106. The site 106 may be referred to herein as an advertising website 106. The website 106 may include a search engine which prompts for search entries. The agency 102 further delivers advertisements 114 that may be displayed on the site 106.

A customer-entered word into a search query may correspond to a purchased keyword. If so, one or more delivered advertisements are displayed. The advertisements may be displayed simultaneously with the search results. The website 106 may also be embodied as any number of various online advertising websites. Advertisements may be displayed in response to customer entries wherein entries are compared to pre-selected keywords. Alternatively, advertisements may be displayed without regard to customer input.

The advertising website 106 may also be configured to display media such as video, pictures, slideshows, presentations, audio and the like. The website 106 may display advertisements simultaneously with the displayed media. The advertisements may be displayed in response to a customer's selection of media. A customer may also enter search terms to locate media and the search terms may be compared with keywords to determine if a match exists. If so, an advertisement may be displayed in conjunction with the media search results.

An advertisement may also be displayed during a certain segment of a media. The segment may correspond to the subject matter of the advertisement. For example, if a video clip displays the Tahitian Islands, an advertisement may also be displayed at the same time for travel services to the Tahitian Islands. If an audio clip relating to sports is discussed, an advertisement may be displayed for clothing featuring sports equipment. If a certain team is discussed, then an advertisement may be displayed with licensed products for that team. A timing index may be associated with media to provide advertisements during certain points during play of the media. Accordingly, the advertisements would correspond with the media and be relevant to the media display.

A customer 108 uses a computer device 110 to access the advertising website 106 over the Internet 112. The computer device 110 includes a browser application suitable for accessing and displaying a website. After accessing the site 106, the customer 108 may enter search terms that correspond to different keywords. The customer 108 may enter a search term that matches a keyword that has been purchased by the agency 102.

As a result of a match or a near match of a purchased keyword, the site 106 displays an advertisement 114 that is associated with the keyword and which promotes the client's business. The advertisement 114 may include text, graphics, video, and other media features. The advertisement 114 is configured to be selectable and includes a link to a client tracking website 116. When a customer 108 clicks on the advertisement 114, the computer device 110 is directed to the client tracking website 116.

The client tracking website 116 may be a similar or nearly duplicate version of a client's normal website. The client tracking website 116 may also be embodied as a client-specific web page. In one embodiment, the website 116 may approximate a mirror version of the client's normal website, with the exception that a new telephone number replaces the client's normal telephone number. The new telephone number is inserted for tracking purposes. If the customer 108 contacts the client's sale force 118 by a telephone call 120, the call 120 is forwarded to the client's business line. The call 120 is also tracked 122 and is recorded in the agency's call logs.

An email on the website 116 may also be modified so that the agency receives a copy of any email submission. If the customer 108 contacts the client by email 124, the email 124 is sent to the client sales force 118. A copy of the email (or other traceable indication) is also sent 126 to the agency. In this way, the agency is able to track the number of emails and phone calls that are generated by search advertising that the agency has purchased.

Generated telephone calls and emails are tracked or otherwise logged and stored in a New Customer Contact Database 128. The Database 128 may be in electrical communication with an agency computer 130 which is programmed to analyze the stored calls and emails. The agency computer 130 may include a processor, memory, and operating software sufficient to operate as described herein. The telephone calls and emails may be analyzed to determine whether they are new customer contacts or customer contacts of repeat customers who have previously contacted the client. As can be appreciated, an analysis may be performed manually; however, it is advantageous to perform the analysis in whole or in part without direct user intervention.

To generate, manage, and monitor the telephone numbers, a third party call tracker application, such as those provided by eStara, VoiceStar, or MediaTraks, may be utilized. These providers enable provisioning of new toll-free or local phone numbers, and the tracking of all activity forwarded through those phone numbers. When a call comes in, the following information may be logged: originating phone number of caller, forward to phone number (client's normal phone number), time and date of call, and duration of call.

In some embodiments, additional information may also be logged, including the name and address of the caller, the status of the call (answer, voice-mail, cancel/hang-up, or time-out), and in certain cases, a sound file recording of the call (e.g., if permission has been granted by the client in writing and the calling customer has been notified that their phone call is being recorded via a sound file notification that plays when the customer calls the tracking phone number.) In the case that a caller hangs-up without speaking to a client representative or leaving a voice-mail, the client may still be charged a fee, assuming that the call is proven to be a new customer contact.

As phone calls are tracked, they are automatically sorted by client and maintained in the New Customer Contact Database 128 with all associated information. This database is updated on an ongoing basis, and periodically the database may be scrubbed to remove duplicate customer contacts.

The agency computer 130 may prepare an activity summary 132 for the client 134. The activity summary 132 may be stored and transmitted to the client 134 in either electronic or hard copy format. The activity summary 132 may be automatically generated periodically based on predetermined scheduling. Alternatively, the agency computer 130 may generate the activity summary 132 when initiated by a user. The activity summary 132 may include all new customer contact activity for a given time period. The activity summary 132 may also include an invoice with an outstanding balance payable by the client. In some embodiments, the new customer contacts are tracked only during each invoice period, while in other embodiments, new customer contacts are tracked across multiple periods.

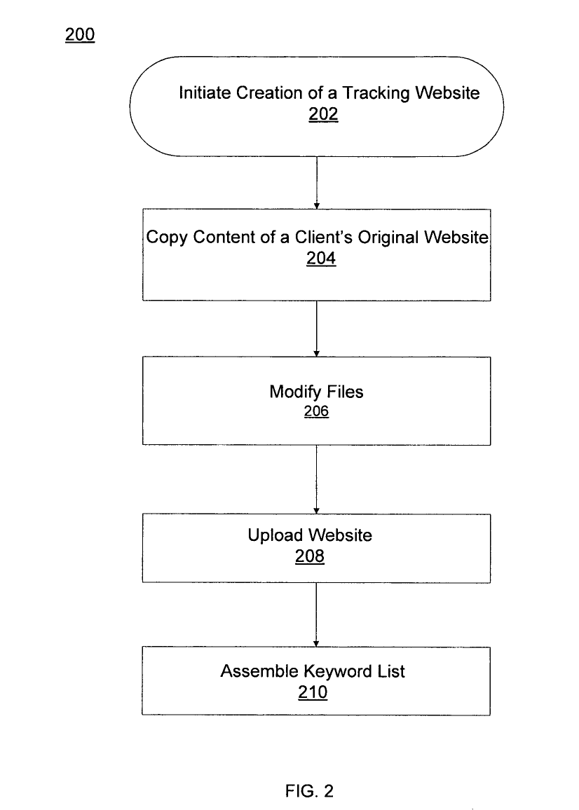

Referring to FIG. 2, a flow diagram of a process 200 for creating a tracking website 116 is shown. Upon engagement with a new client, an agency initiates 202 creation of a client tracking website that is used for tracking purposes. The client engagement may include an agreement for a price per new customer contact. The content of a client's original website is copied 204.

Certain files are modified 206 to replace previous client contact information with tracking contact information. In the tracking website, the previous phone number may be replaced with a new tracking phone number throughout. The email may be modified so that the agency is sent a copy of any email inquiry the client receives. The subject line of the email that the client receives is modified to indicate that the email contact is provided by the agency's advertising.

The email may be configured in a form with fields that a customer completes before sending. To avoid having to modify server-side scripts, a third party remote form processor, such as FormMail.com, may be utilized to process email forms and automatically send them to the client and to the agency. The agency may work with the client to determine which of the form fields will be required. If the customer does not complete one of the required form fields, then the customer receives an error and is directed to complete all required forms before the inquiry is sent to the client and to the agency for tracking.

A client website may not include a form for email, but instead simply list a client's email address with a mail-to link to email the client directly at this address. In this case, all appearances of the client's email address may be replaced with a new form in the tracking website for the customer to input their information. The agency may work with the client to determine what fields appear in this form. An email form may includes fields for information, such as customer name, customer address, customer email address, customer phone number, and nature of inquiry. As in the case above, a third party remote form processor may be utilized to process a customer-submitted form and transmit it to the client and to the agency for tracking.

As can be appreciated, an email form provides a number of benefits: 1) an email form enables the client to receive specific information which might not otherwise be included by a customer in a regular email; 2) an email form allows the agency to be transparent to the customer, without any non-client email address actually appearing to the customer; and 3) an email form allows for the tracking of conversions for search advertising optimization purposes using tracking code, such as Google Conversion Tracking.

Alternately, a substitute email address may be employed that is configured to send a copy to the agency as well as to the client. As emails and/or form submissions are received by the agency, they are automatically sorted and maintained in the New Customer Contact Database with all associated information in the email. The New Customer Contact Database may be updated on an ongoing basis. At the end of a certain period of time, such as a calendar month, the Database may be scrubbed to remove duplicate customer contacts.

In some embodiments, a client's website may support dynamic calls to a server-side database. In such embodiments, a third party technology, such as KeywordRanking.com, may be utilized to dynamically replace telephone numbers and email addresses through the use of proxy web pages. In this case, a separate duplicate website may not be needed.

Instead, a customer arrives at a client's website after clicking on a search advertisement. A tracking telephone number or tracking email is dynamically inserted in the client's existing website, replacing all instances of the client's previous phone number. This technique may cause time delays that impede the customer experience. Since the core focus on these third-party technology solutions has been to track offline, i.e., telephone calls, the use of this technique may create certain challenges with email form tracking for new customer contacts. In some embodiments, these issues may be resolved, and thus this type of third party technology may increasingly be utilized as it enables the ability to further optimize results.

After a tracking website is created, the website is uploaded 208 to a web server. The tracking website may be placed at a sub-domain of a server controlled by the agency. The tracking website may also be placed on an alternate server and domain controlled by the agency or the client, depending on any special technical requirements and/or client preferences.

Along with the creating, launching, and testing of a tracking website, a keyword list is assembled 210 representing key words that customers may use when looking for the client's product or service. To create this list, various sources of information are utilized, such as a thesaurus, third party keyword mining tools, such as Wordtracker.com, search engine/online advertising keyword tools, and general past experiences. Bids may then be placed on keywords in the list, using third party bid management software or working directly with the search engine/online advertising interfaces. As keywords are purchased, advertisements are generated to entice customers to click on the search advertisements, and the campaign is launched.

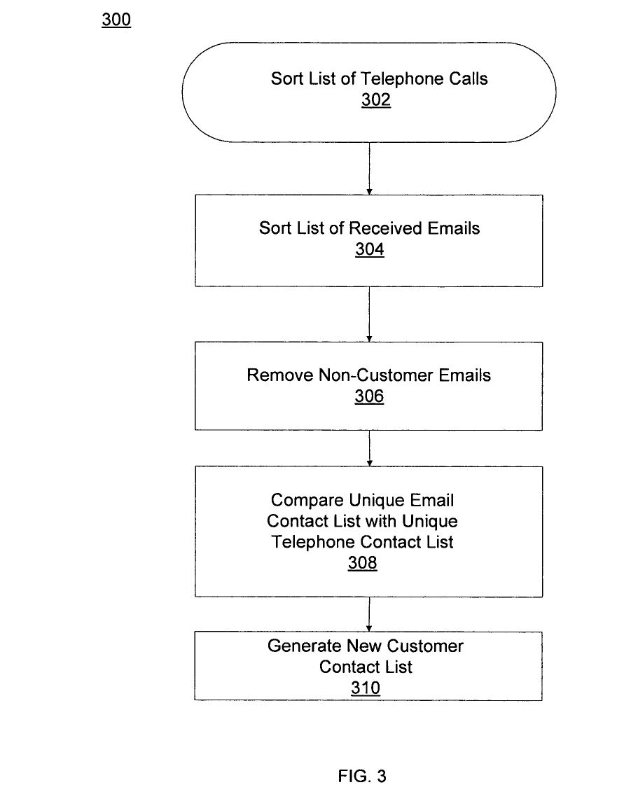

Referring to FIG. 3, a flow diagram of a process 300 for determining the number of new customer contacts each client receives is shown. The process 300 may also be referred to as a de-duplication process, as it removes redundant, repetitive customer contacts. For example, if a customer calls a client, and also sends an email to a client, then the client is only charged for a single new customer contact.

The first step in this process 300 is to sort 302, by client, the list of telephone calls generated by use of the tracking telephone numbers. If the same originating caller phone number appears multiple times, any calls beyond the first call by that caller are disregarded. This results in a unique phone contact list for each client. Next, the list of emails received by that client are sorted 304 in a similar process. As determined by email address and phone number, any emails beyond the first email sent by that customer to a specific client are disregarded. This results in a unique email contact list for each client.

Once a de-duplicated email contact list is prepared for each client, non-customer emails may be removed 306. This may be done automatically, or an editorial review team may manually read each email inquiry and remove any emails from individuals seeking employment by the client, or vendors attempting to sell products and/or services to the client.

For each client, once the list of unique email contacts and unique phone contacts are compiled, the next step is to compare 308 the unique email contact list with the unique telephone contact list on a client-by-client basis. If a customer telephone number from the telephone contact list appears within any email record (e.g., header information, domain name records, email message, email signature, and the like) in the email contact list, then that corresponding telephone call is disregarded. If a street address can be captured using reverse phone director look-up in a call record, and that street address appears within any email record in the unique email contact list, then that call is disregarded. If a name can be captured using reverse phone directory look-up in a call record, and that name appears within any email record in the unique email contact list, then that call is not disregarded unless the address and/or the caller phone number also appear in the unique email contact list.

The process concludes with the generation 310 of a new customer contact list for a client. The process 300 may be repeated for each client periodically. For invoicing purposes, the new customer contact list may be forwarded to the client, and the client pays an agreed upon fee for each new customer contact in a time period (e.g., month, week, quarter, year, day, hour, etc.). The client may also receive a summary of the duplicate customer contacts, but the purpose of this is to provide additional information to the client and not to affect invoicing of the pay-per-new-customer.

If the client decides to terminate the relationship with the agency, then all search advertising ceases, the duplicate site is removed from the Internet, and the tracking contact information is no longer operational. In the case of termination, a client may be responsible for payment of all new customer contacts delivered up to the period of termination.

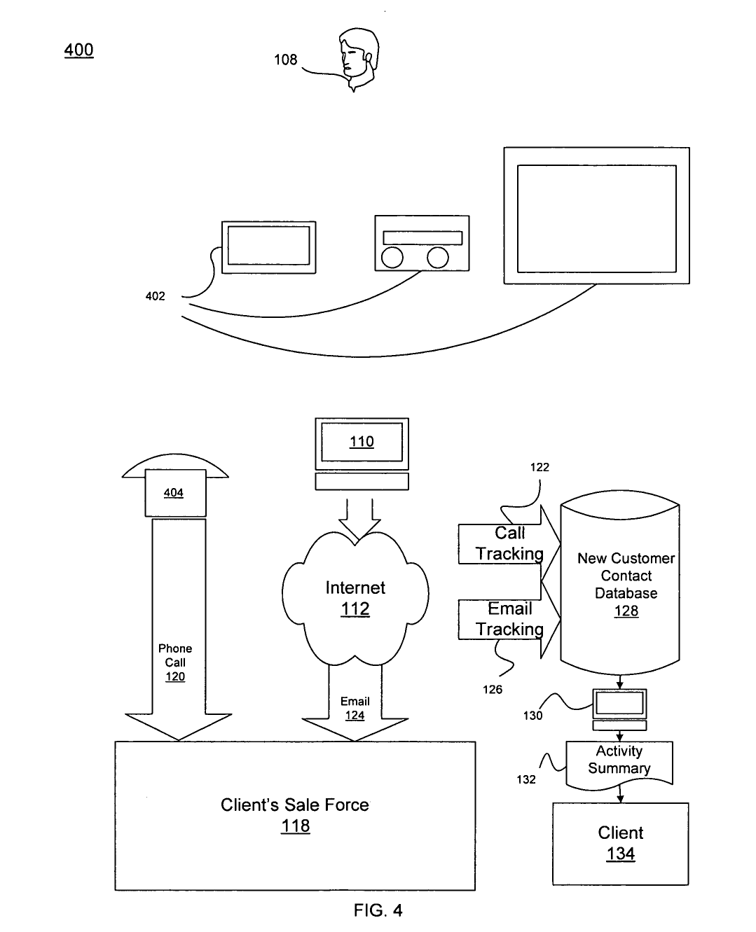

Referring to FIG. 4, a block diagram of an alternative marketing system and process 400 used to offer advertising services and track new customer contacts is shown. An agency 102 promotes a client's good or services through video and/or audio communication through off-line media devices 402. The devices 402 may include television, radio, digital billboard and the like. The devices convey contact information in the video and/or audio communication. The contact information may include a telephone number or email address that may be used for tracking. The contact information may be displayed simultaneously with a video broadcast or placed within an advertisement. A customer may enter the contact information into a telephone device 404 or a computer device 110 to contact a client's sale force 118. The call 120 or email 124 is tracked and logged in a manner similar to that described above.

In an alternative embodiment, the off-line media devices 402 may convey search terms that may be entered into an on-line search engine. When a customer later accesses a search engine, the customer may enter the search terms. The on-line search engine may have keywords that are matched to the search terms in a manner previously discussed. In one example, a media device 402 may convey the terms “handyman los angeles.” When a customer enters these terms into an on-line search engine, an advertisement is displayed on an advertising website which links to a client tracking website. This technique operates in a manner similar to that disclosed in FIG. 1 with the addition of preliminary contact to a customer through a media device.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. A system for tracking new customer contacts, comprising:
a client tracking website including tracking contact information usable by a customer to contact a client;
a new customer contact database to receive and log contact information upon use of the tracking contact information to contact a client; and
an agency computer in electrical communication with the new customer contact database to analyze the contact information and generate a new customer contact list including new customer contacts.

2. The system of claim 1, wherein the client tracking website is substantially similar to a previously-generated original client website.

3. The system of claim 1, further comprising an advertising website configured to display an advertisement upon entry of a keyword, wherein the advertisement includes a link to the client tracking website.

4. The system of claim 1, wherein the tracking contact information is a telephone number.

5. The system of claim 1, wherein the tracking contact information is an email form.

6. The system of claim 1, wherein the tracking contact information is an email address.

7. The system of claim 1, wherein the agency computer is configured to generate an activity summary of new customer contacts.

8. The system of claim 6, wherein the activity summary includes an invoice corresponding to the new customer contacts.

9. A method for tracking new customer contacts, comprising:
generating a client tracking website including tracking contact information usable by a customer to contact a client;
providing a new customer contact database to receive and log contact information;
the new customer contact database receiving and logging the contact information upon a customer using the tracking contact information to contact client; and
analyzing the contact information and generating a new customer contact list including new customer contacts.

10. The method of claim 9, wherein generating the client tracking website includes copying content of a previously-generated original client website to create the client tracking website that is substantially similar to the original client website.

11. The method of claim 10, wherein generating the client tracking website includes replacing contact information on the original client website with tracking contact information.

12. The method of claim 9, wherein the tracking contact information is a telephone number.

13. The method of claim 9, wherein the tracking contact information is an email form.

14. The method of claim 9, wherein the tracking contact information is an email address.

15. The method of claim 9, further comprising:
delivering an advertisement to an advertising website, the advertisement including a link to the client tracking website; and
the advertising website displaying the advertisement upon entry of a keyword.

16. The method of claim 15, wherein search terms are conveyed to the customer through a media device prior to the advertising website displaying the advertisement upon entry of a keyword.

17. The method of claim 9, further comprising:
generating an activity summary of new customer contacts; and
delivering the activity summary to a client.

18. The method of claim 17, wherein the activity summary includes an invoice corresponding to the new customer contacts.

19. The method of claim 9, wherein the contact information includes telephone call information and email information and further comprising:
sorting the telephone call information to remove duplicate telephone calls originating from the same customer;
sorting the email information to remove duplicate emails originating from the same customer;
identifying and removing non-customer email information;
comparing telephone call information and email information to remove contact information originating from the same customer; and
generating a new customer contact list including a plurality of new customers, wherein each new customer is listed once.

20. A computer readable medium having stored thereon computer executable instructions for performing a method for tracking new customer contacts, the method comprising:
providing tracking contact information on a client tracking website, the client tracking website including content of an original client website, the tracking contact information corresponding to contact information on the original client website and usable by a customer to contact a client;
receiving contact information generated by a customer using the tracking contact information to contact a client;
logging the contact information in a database; and
analyzing the contact information and generating a new customer contact list including new customer contacts.

21. The computer readable medium of claim 20, wherein the tracking contact information is a telephone number.

22. The computer readable medium of claim 20, wherein the tracking contact information is an email form.

23. The computer readable medium of claim 20, wherein the tracking contact information is an email address.

24. The computer readable medium of claim 20, wherein the method further comprises:
providing an advertisement on an advertising website, the advertisement including a link to the client tracking website; and
displaying the advertisement upon entry of a keyword.

25. The computer readable medium of claim 20, wherein the method further comprises:
generating an activity summary of new customer contacts; and
transmitting the activity summary to a client.

26. The computer readable medium of claim 25, wherein the activity summary includes an invoice corresponding to the new customer contacts.

27. The computer readable medium of claim 20, wherein the contact information includes telephone call information and email information and wherein the method further comprises:
sorting the telephone call information to remove duplicate telephone calls originating from the same customer;
sorting the email information to remove duplicate emails originating from the same customer;
identifying and removing non-customer email information;
comparing telephone call information and email information to remove contact information originating from the same customer; and
generating a new customer contact list including a plurality of new customers, wherein each new customer is listed once.

28. A method for tracking new customer contacts, comprising:
providing tracking contact information to an off-line media device, the media device configured to play media content and convey the tracking contact information;
providing a new customer contact database to receive and log contact information;
the new customer contact database receiving and logging the contact information upon a customer using the tracking contact information to contact a client; and
analyzing the contact information and generating a new customer contact list including new customer contacts.

29. The method of claim 28, wherein the tracking contact information is a telephone number.

30. The method of claim 28, wherein the tracking contact information is an email address.

31. The method of claim 28, further comprising:
generating an activity summary of new customer contacts; and
delivering the activity summary to a client.

32. The method of claim 31, wherein the activity summary includes an invoice corresponding to the new customer contacts.

33. The method of claim 28, wherein the contact information includes telephone call information and email information and further comprising:
sorting the telephone call information to remove duplicate telephone calls originating from the same customer;
sorting the email information to remove duplicate emails originating from the same customer;
identifying and removing non-customer email information;
comparing telephone call information and email information to remove contact information originating from the same customer; and
generating a new customer contact list including a plurality of new customers, wherein each new customer is listed once.
